(19) United States
(12) Patent Application Publication
(10) Pub. No.: US 2013/0325883 A1
(43) Pub. Date: Dec. 5, 2013

(54) PRESERVING DATA INTEGRITY ACROSS INCOMPATIBLE COMPUTER ARCHITECTURES

(71) Applicants: Kelsey L. Bruso, Minneapolis, MN (US); James M. Plasek, Storeview, MN (US); Michael S. Jende, White Bear Lake, MN (US)

(72) Inventors: Kelsey L. Bruso, Minneapolis, MN (US); James M. Plasek, Storeview, MN (US); Michael S. Jende, White Bear Lake, MN (US)

(21) Appl. No.: 13/486,162

(22) Filed: Jun. 1, 2012

(51) Int. Cl. G06F 17/30

(52) U.S. Cl. CPC G06F 17/30283
USPC 707/756

(57) ABSTRACT

Values may be interchanged between computers with different computer architectures by implementing a transform function in a database serving the values to the computers. The transform function may convert a value for use on a computer with a different word length than the word length of the computer hosting the database. For example, the database may have 36-bit words, and a client may have 32-bit words. The transform function may operate without data loss and be capable of reversing the transform to enable round trips for data between the database and client.

The instant disclosure relates to data communications. More specifically, this disclosure relates to converting data for communication between dissimilar computer architectures.

### BACKGROUND

Computer architectures are designed to operate on data in specific-sized chunks, known as words. Each word comprises a predefined number of bits, and hardware for a computer system is designed to match the chosen word length. Certain word lengths may be preferred depending on the applications executed by the computer architecture. Character size may be one consideration when word length is selected. For example, before the 1960s, characters were most often stored in 6-bit representations, which limited the character set to 64 characters. Generally, efficiency is gained by selecting a word length to be a multiple of the character size. Thus, one choice for word length in computer architectures was 36 bits. Other word lengths selected for computer architectures include 8 bits, 16 bits, 32 bits, and 64 bits.

Recently, the number of different computer architectures in operation has increased and communications between computers systems has also increased. Thus, data sharing among these disparate computer architectures is becoming more common. The data must be transformed from one architectural representation to another in an efficient and loss-less manner to support the use of the data during communications such as on-line transaction processing and in business intelligence processing.

Data generally resides in databases stored in server computer systems. Previously, if a client requested data from a column in a database containing 9-bit bytes, the client would be unable to retrieve this data directly using a database connector. One prior solution to this problem is to call a Java native interface (JNI) from Java to execute a C-program running on the 9-bit platform. That program transformed the data into 8-bit bytes and returned that value to the Java program. The transformation of the data from one computer architecture to another was performed outside the database management system in the application itself. The application-specific solutions handled the data items on a case by case basis. Thus, application developers were required to develop transformation programs for each application that was developed.

### SUMMARY

According to one embodiment, a method includes receiving, from a database on a host computer, a first value represented by a bit pattern of a first computer architecture. The method also includes transforming, in the database on the host computer, the first value to a second value represented by a bit pattern of a second computer architecture. The method further includes transferring the second value to a client computer of the second computer architecture.

According to another embodiment, a computer program product includes a non-transitory computer readable medium having code to receive, from a database on a host computer, a first value represented by a bit pattern of a first computer architecture. The medium also includes code to transform, in the database on the host computer, the first value to a second value represented by a bit pattern of a second computer architecture. The medium further includes code to transfer the second value to a client computer of the second computer architecture.

According to a further embodiment, an apparatus includes a memory and a processor coupled to the memory. The processor is configured to receive, from a database on a host computer, a first value represented by a bit pattern of a first computer architecture. The processor is also configured to transform, in the database on the host computer, the first value to a second value represented by a bit pattern of a second computer architecture. The processor is further configured to transfer the second value to a client computer of the second computer architecture.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a method of transforming data within a database according to one embodiment of the disclosure.

FIG. 2 is a flow chart illustrating a method of transforming data from a first word length to a second word length according to one embodiment of the disclosure.

FIG. 3 is a graphic illustrating transformation of data from a first word length to a second word length of a smaller length according to one embodiment of the disclosure.

FIG. 4 is a graphic illustrating transformation of data from a first word length to a second word length of a larger length according to one embodiment of the disclosure.

FIG. 5 is a graphic illustrating transformation of data from a first word length to a second word length and back along with intermediate steps according to one embodiment of the disclosure.

FIG. 6 is a graphic illustrating transformation of data from a first word length to a second word length with a different sized bit grouping according to one embodiment of the disclosure.

FIG. 7 is block diagram illustrating a computer network according to one embodiment of the disclosure.

FIG. 8 is a block diagram illustrating a computer system according to one embodiment of the disclosure.

FIG. 9A is a block diagram illustrating a server hosting an emulated software environment for virtualization according to one embodiment of the disclosure.

FIG. 9B is a block diagram illustrating a server hosing an emulated hardware environment according to one embodiment of the disclosure.

### DETAILED DESCRIPTION

A transformation function within a database may be used to convert a value from one representation for a computer architecture to another representation for a different computer architecture. The function may take a string argument, s1, containing data in one architectural representation and return a string, s2, with the data transformed to a second format, which can be transferred with reduced or no loss to the second architectural representation. The transform function may provide lossless transfer of binary data between incompatible computer architectures. According to one embodiment, the transform function may manipulate bits of s1 such that 9-bit binary data, stored in a character or binary large object (BLOB) column of the database, may be transferred to 32-bit programs. The 32-bit programs (such as Java programs, which interact with a database management system (DMS) using a Java database connector (JDBC)) receive the 9-bit data without losing any bits of each byte during the transfer of the data by the JDBC to the Java program.

The transformation may occur bi-directionally within the database management system (DMS). By transforming data in the database, the burden for transforming data may be removed or reduced from the application. Further, by localizing the transformation to the database, the transformations may be made consistent across all applications, which allows enforcement of business rules more effectively.

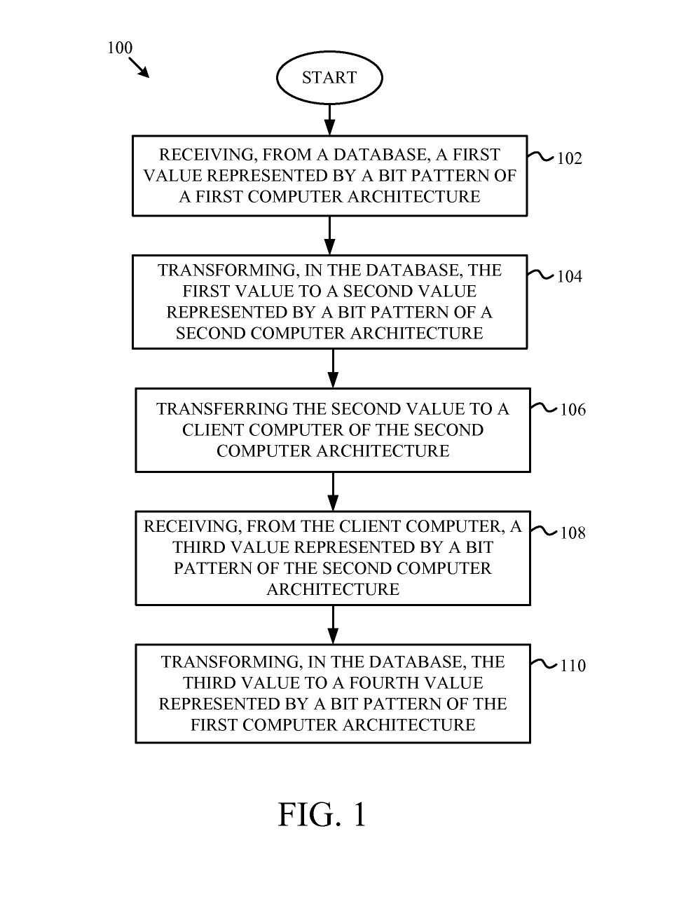

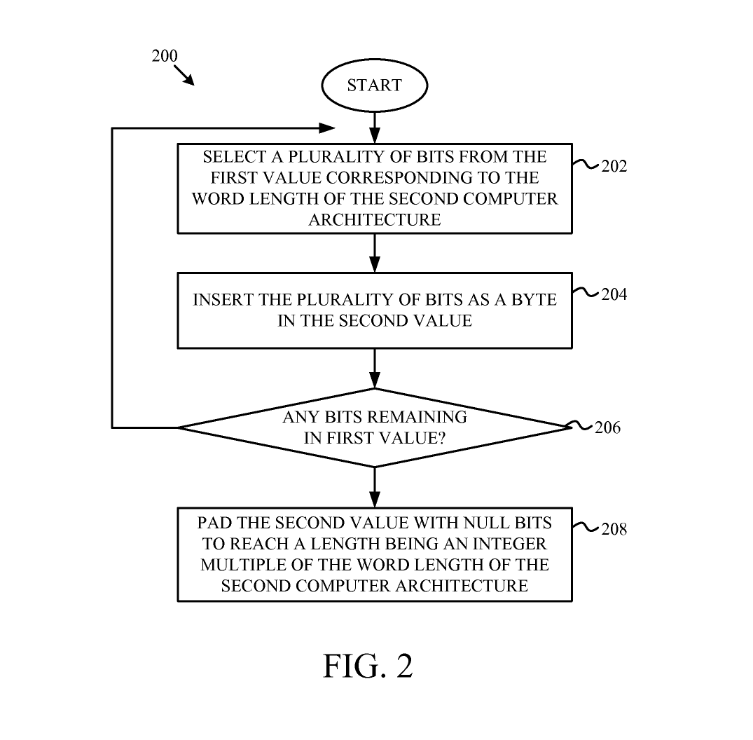

FIG. 1 is a flow chart illustrating a method of transforming data from a first word length to a second word length according to one embodiment of the disclosure. A method 100 begins at block 102 with receiving, from a database, a first value represented by a bit pattern of a first computer architecture. For example, the first value may be represented in a string of bits organized into 36-bit words with 9-bit bytes. At block 104, the first value may be transformed into a second value represented by a bit pattern of a second computer architecture. For example, the second value may be a string of bits organized into 32-bit words with 8-bit bytes. Additional details regarding the transformation step are discussed below with reference to FIGS. 2-7. At block 106, the second value may be transferred to a client computer of the second computer architecture. For example, the client computer may be a 32-bit computer system that requested the first value from the database. The database received the first value and transformed the first value into the second value, which reduces processing performed by the client computer when interfacing with the database. Additionally, once the data is transformed, the data may be exchanged freely among computers have the same architecture as the client computer with no loss of information (or “no-loss-of-fidelity”) during the data exchanges.

The method 100 may continue with receiving data back from the client computer for storage in the database. For example, the client computer may perform processing on the second value to arrive at a third value, or the client computer may calculate a third value based on the second value. The third value may be received by the database from the client computer, and the third value may be represented by a bit pattern of the second computer architecture. At block 110, the third value is transformed into a fourth value represented by a bit pattern of the first computer architecture. That is, a reverse transformation function in the database may transform values back to the representation of the first computer architecture. When the second value is the same value as the third value, that is the same value is being reverse transformed, there may be no loss of data.

FIG. 2 is a flow chart illustrating a method of transforming data from a first word length to a second word length according to one embodiment of the disclosure. Data may be transformed from a first computer architecture to a second computer architecture by shifting the meaningful value bits. At block 202, a plurality of bits from the first value corresponding to a byte in the second computer architecture are selected. For example, when the second computer architecture uses 32-bit words, the first eight bits of the first value are selected. At block 204, those bits may be inserted into the second value as a first byte.

If additional bits remain in the first value at block 206, the method 200 returns to block 202 to repeat the process. For example, if additional bits remain in the first value, the next eight bits are selected. On the second repetition, the next eight bits may consist of the last bit of the first 9-bit byte in the first value plus seven additional bits from the second 9-bit byte in the first value.

If fewer than the number of bits in the word length of the second computer architecture exist at block 202, then as many bits as remain in the first value are selected. After all bits of the first value are inserted into the second value, the method 200 continues to block 208 to pad the second value with null bits to reach a length being an integer multiple of the word length of the second computer architecture. For example, if the second computer architecture has a word length of 32-bits and the second value has 31 bits at the end of block 206, then the second value may be padded with one null bit. The padding may be placed at any location within the second value. According to one embodiment, the padding may be placed at the beginning or end of the string of bits in the second value. The null bit may be either a ‘0’ or a ‘1.’

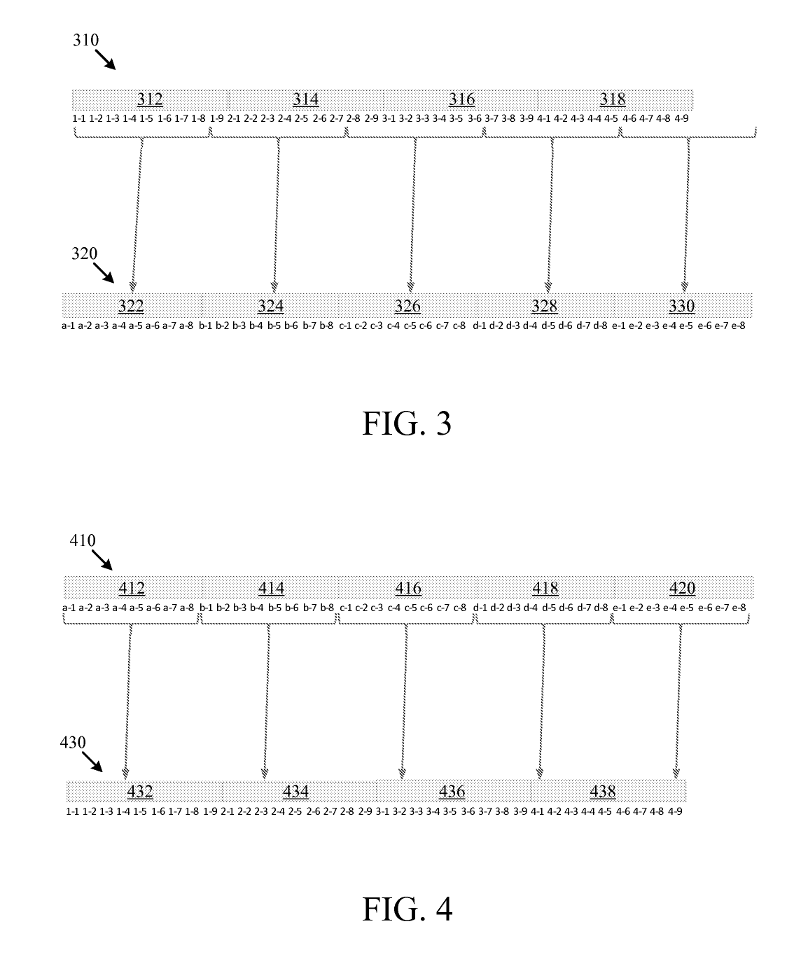

FIG. 3 is a graphic illustrating transformation of data from a first word length to a second word length of a smaller length according to one embodiment of the disclosure. The first computer architecture may have nine bits per byte. A first value 310 may include bytes 312-318, and each byte 312-318 may have bits numbered 1 to 9 in the four bytes numbered 1 to 4 (1-1, 1-2, 1-3, . . . 4-7, 4-8, 4-9) of a 36-bit word. A second value 320 may include bytes 322-330, each byte having eight bits. The eight bits per byte are numbered 1 to 8 in the four bytes numbered a to d (a-1, a-2, a-3, . . . d-6, d-7, d-8). The data representation 320 may be exchanged freely among computers having an eight bits per byte data representation with no loss of the nine bits per byte information.

To restore the data to the representation of the first computer architecture, reverse processing may be performed to move groups of eight adjacent bits from the eight bits per byte representation into the nine bits per byte representation, as shown in FIG. 4. FIG. 4 is a graphic illustrating transformation of data from a first word length to a second word length of a larger length according to one embodiment of the disclosure. A third value 410, including 8-bit bytes 412-420 may be transformed into a fourth value 430 having nine bits per byte.

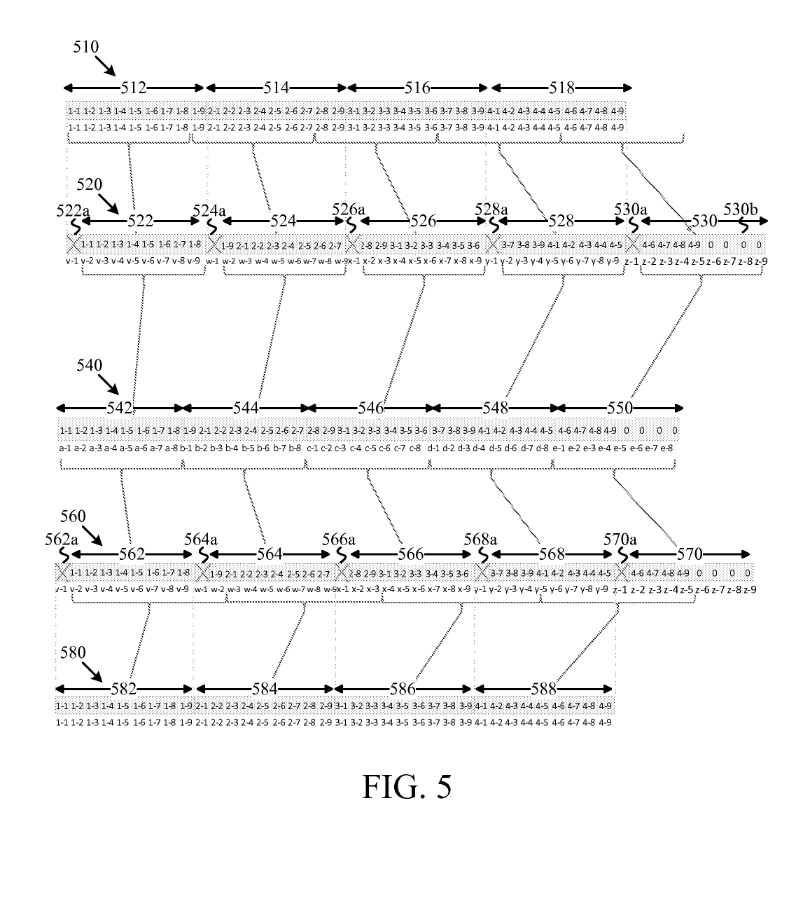

Transformation of data as described above may allow loss-less transfer of data from a first computer architecture to a second computer architecture. Loss-less transformation allows ‘round trip’ processing, in which the original data is transferred to a different machine architecture, processed in the different machine architecture, and then returned, intact, to the original system. One transformation function for round trip processing is illustrated in FIG. 5.

FIG. 5 is a graphic illustrating transformation of data from a first word length to a second word length and back along with intermediate steps according to one embodiment of the disclosure. A first value 510 is moved from 9-bit bytes 512-518 in groups of eight adjacent bits 522-530 to an intermediate value 520, which is another nine bits per byte representation. In the intermediate value 520, each of the groups of eight adjacent bits 522-530 is preceded by a null bit 522a-530a. Although the null bit is shown preceding each eight adjacent bits, the null bit may be inserted anywhere in the eight adjacent bits. The bits, numbered 1 to 9 in each of the four bytes numbered 1 to 4 (1-1, 1-2, 1-3, . . . 4-7, 4-8, 4-9) appear in the intermediate value 520 in corresponding bytes numbered v-1 to z-9.

The intermediate value 520 may then be transformed into a second value 540 by moving groups of eight adjacent bits from bits 2 to 9 of bytes v to z into corresponding eight bits per byte representation in bytes 542-550. Because the number of bits in the first value 510 may not be an even multiple of the word length of the second value 540, padding 530b is added to the intermediate value 520 and carried over to the second value 540.

The second value 540 may be transformed back into the format of the first value 510. That is, the transformation function from the first value 510 to the second value 540 is reversible. The 8-bit bytes 542-550 of the second value 540 are selected and placed into 9-bit bytes 562-570 of an intermediate value 560. Each of the bytes 562-570 may include one or more padding bits 562a-570a. The number of padding bits in each of the bytes 562-570 may be selected based, in part, on the number of additional bits in each of the bytes 562-570 in addition to the bits in the bytes 542-550 of the second value 540. For example, if bytes 542-550 are 8-bit bytes and bytes 562-570 are 9-bit bytes, each of the bytes 562-570 may include one padding bit (the difference between nine and eight).

The bytes 562-570 of the intermediate value 560 may then be copied into the value 580 by selecting adjacent non-null bits from the intermediate value 560. For example, the byte 582 may include 9 bits selected as the 8 non-null bits in the byte 562 and one non-null bit from the byte 564. At the end of the value 580, the padding bits that were added to complete a word in the second value 540 are dropped.

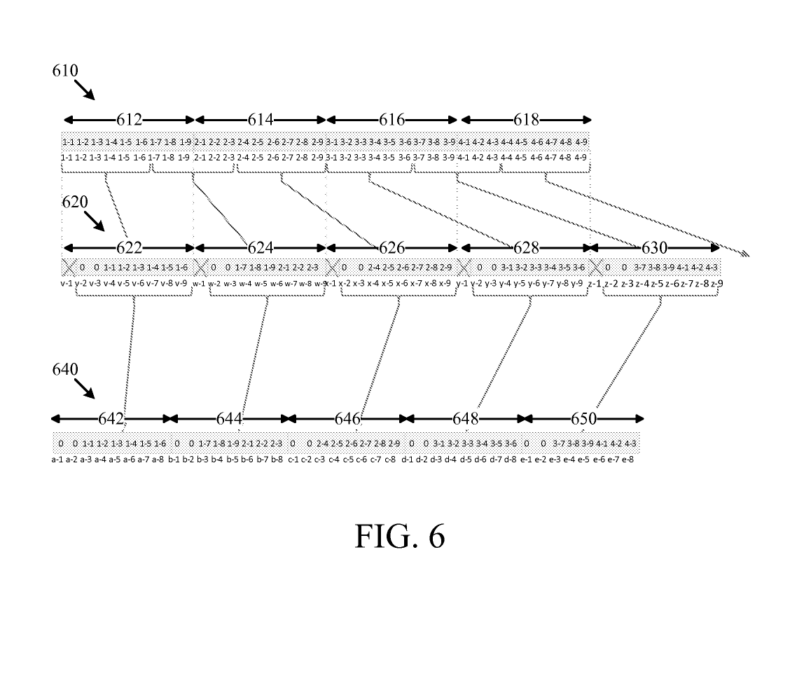

The transformation function may be extended to other sized bit groupings than the 8-bit and 9-bit groupings described above. For example, a 36-bit word may be organized as either four 9-bit bytes or six 6-bit bytes. FIG. 6 is a graphic illustrating transformation of data from a first word length to a second word length with a different sized bit grouping according to one embodiment of the disclosure. A first value 610 may include 9-bit bytes 612-618. Bits from the bytes 612-618 may be selected in 6-bit groups and placed in 9-bit bytes 622-630 of an intermediate value 620. Each of the bytes 622-630 then contains six bits of data and three padding bits. The six bits of data from the bytes 622-630 may be selected, along with two padding bits, and placed in 8-bit bytes 642-650 of a second value 640.

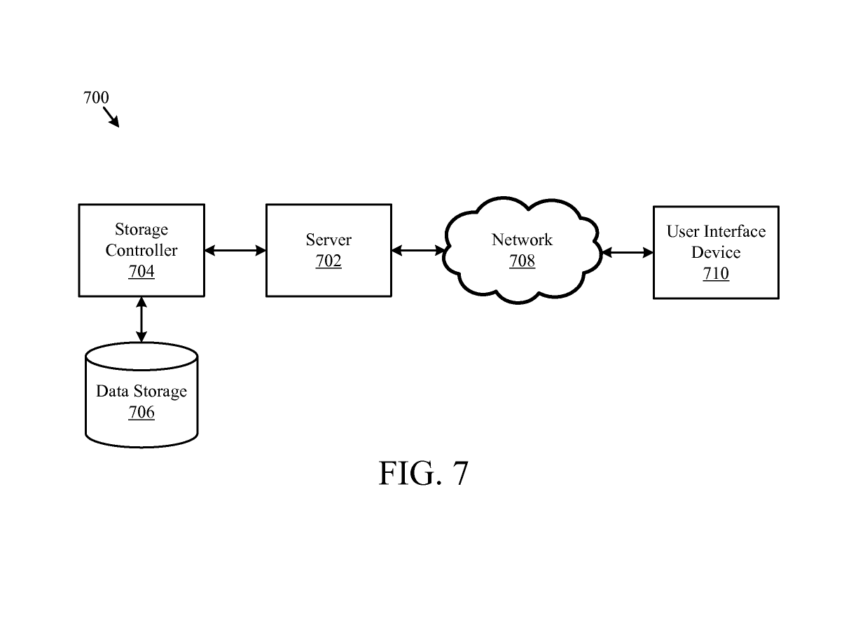

FIG. 7 illustrates one embodiment of a system 700 for an information system, including a database that may execute the transformation functions described above. The system 700 may include a server 702, a data storage device 706, a network 708, and a user interface device 710. The server 702 may be a dedicated server or one server in a cloud computing system. The server 702 may also be a hypervisor-based system executing one or more guest partitions. In a further embodiment, the system 700 may include a storage controller 704, or storage server configured to manage data communications between the data storage device 706 and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or tablet computer, a smartphone or other a mobile communication device having access to the network 708. When the device 710 is a mobile device, sensors (not shown), such as a camera or accelerometer, may be embedded in the device 710. When the device 710 is a desktop computer the sensors may be embedded in an attachment (not shown) to the device 710. In a further embodiment, the user interface device 710 may access the Internet or other wide area or local area network to access a web application or web service hosted by the server 702 and provide a user interface for enabling a user to enter or receive information.

The network 708 may facilitate communications of data, such as authentication information, between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 710 accesses the server 702 through an intermediate sever (not shown). For example, in a cloud application the user interface device 710 may access an application server. The application server fulfills requests from the user interface device 710 by accessing a database management system (DBMS). In this embodiment, the user interface device 710 may be a computer or phone executing a Java application making requests to a JBOSS server executing on a Linux server, which fulfills the requests by accessing a relational database management system (RDMS) on a mainframe server.

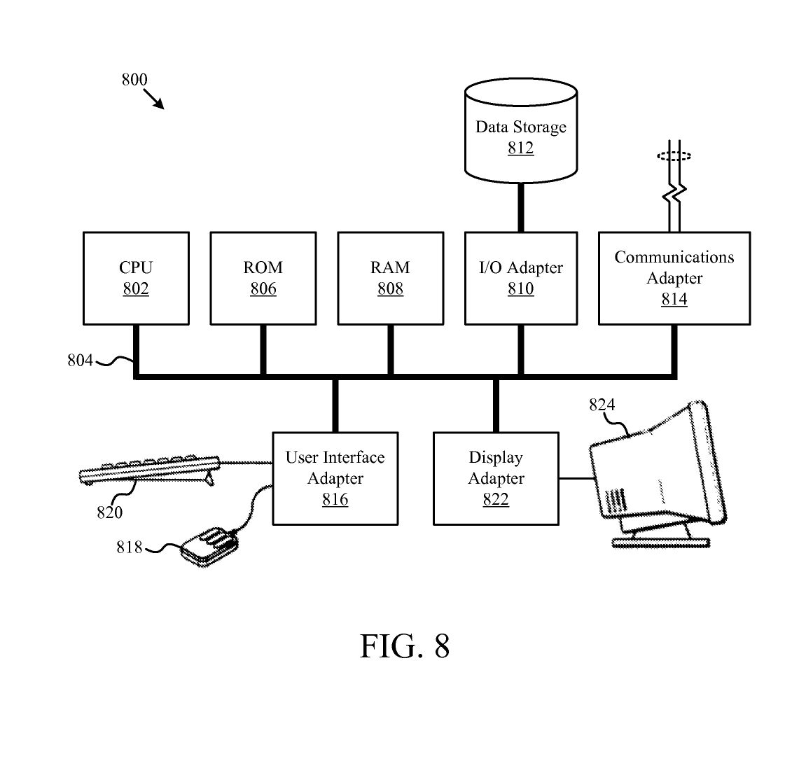

FIG. 8 illustrates a computer system 800 adapted according to certain embodiments of the server 702 and/or the user interface device 710. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 also may include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The communications adapter 814 may also be adapted to couple the computer system 800 to other networks such as a global positioning system (GPS) or a Bluetooth network. The user interface adapter 816 couples user input devices, such as a keyboard 820, a pointing device 818, and/or a touch screen (not shown) to the computer system 800. The keyboard 820 may be an on-screen keyboard displayed on a touch panel. Additional devices (not shown) such as a camera, microphone, video camera, accelerometer, compass, and or gyroscope may be coupled to the user interface adapter 816. The display adapter 822 may be driven by the CPU 802 to control the display on the display device 824. Any of the devices 802-822 may be physical, logical, or conceptual.

The applications of the present disclosure are not limited to the architecture of computer system 800. Rather the computer system 800 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 800 may be virtualized for access by multiple users and/or applications.

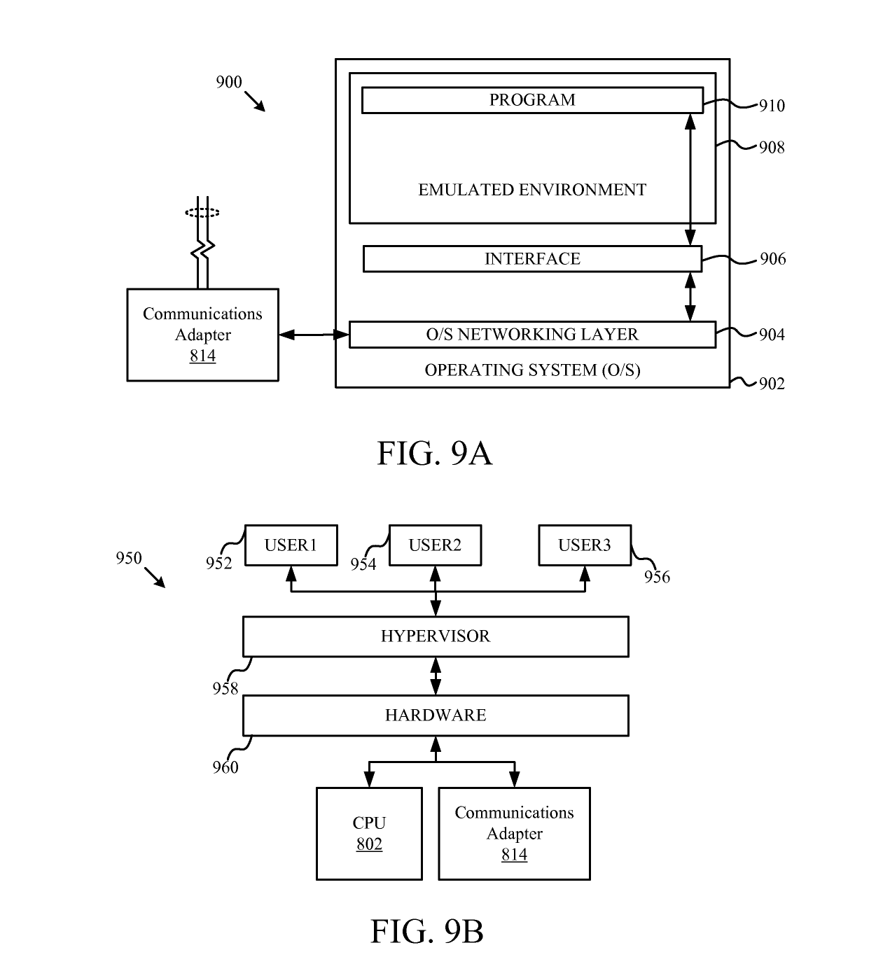

FIG. 9A is a block diagram illustrating a server hosting an emulated software environment for virtualization according to one embodiment of the disclosure. An operating system 902 executing on a server includes drivers for accessing hardware components, such as a networking layer 904 for accessing the communications adapter 814. The operating system 902 may be, for example, Linux. An emulated environment 908 in the operating system 902 executes a program 910, such as CPCommOS. The program 910 accesses the networking layer 904 of the operating system 902 through a non-emulated interface 906, such as XNIOP. The non-emulated interface 906 translates requests from the program 910 executing in the emulated environment 908 for the networking layer 904 of the operating system 902.

In another example, hardware in a computer system may be virtualized through a hypervisor. FIG. 9B is a block diagram illustrating a server hosing an emulated hardware environment according to one embodiment of the disclosure. Users 952, 954, 956 may access the hardware 960 through a hypervisor 958. The hypervisor 958 may be integrated with the hardware 960 to provide virtualization of the hardware 960 without an operating system, such as in the configuration illustrated in FIG. 9A. The hypervisor 958 may provide access to the hardware 960, including the CPU 802 and the communications adaptor 814.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, from a database on a host computer, a first value represented by a bit pattern of a first computer architecture;
transforming, in the database on the host computer, the first value to a second value represented by a bit pattern of a second computer architecture; and
transferring the second value to a client computer of the second computer architecture.

2. The method of claim 1, in which the first computer architecture comprises a first word length larger than a second word length of the second computer architecture, and in which the step of transforming comprises:
selecting a first plurality of bits corresponding to the second word length from the first value; and
inserting the first plurality of bits as a first byte of the second value.

3. The method of claim 2, further comprising forming an intermediate value by inserting the first plurality of bits and one or more null bits as a first intermediate byte before inserting the first plurality of bits as the first byte of the second value.

4. The method of claim 2, further comprising inserting one or more null bits in the first value such that a length of the first value is an integer multiple of the second word length.

5. The method of claim 2, further comprising:
receiving, from the client computer, a third value represented by a bit pattern of the second computer architecture;
transforming, in the database on the host computer, the third value to a fourth value represented by a bit pattern of the first computer architecture; and
storing the fourth value in the database.

6. The method of claim 5, in which the step of transforming comprises:
forming a second intermediate value by inserting one or more null bits into the third value;
selecting a second plurality of bits corresponding to the first word length from the second intermediate value; and
inserting the second plurality of bits as a first byte of the fourth value.

7. The method of claim 1, in which the first value is a binary large object (BLOB) value from a column of the database.

8. A computer program product, comprising:
a non-transitory computer readable medium comprising:
code to receive, from a database on a host computer, a first value represented by a bit pattern of a first computer architecture;
code to transform, in the database on the host computer, the first value to a second value represented by a bit pattern of a second computer architecture; and
code to transfer the second value to a client computer of the second computer architecture.

9. The computer program product of claim 8, in which the first computer architecture comprises a first word length larger than a second word length of the second computer architecture, and in which the medium further comprises code:
to select a first plurality of bits corresponding to the second word length from the first value; and
to insert the first plurality of bits as a first byte of the second value.

10. The computer program product of claim 9, in which the medium further comprises code to form an intermediate value by inserting the first plurality of bits and one or more null bits as a first intermediate byte before inserting the first plurality of bits as the first byte of the second value.

11. The computer program product of claim 9, in which the medium further comprises code to insert one or more null bits in the first value such that a length of the first value is an integer multiple of the second word length.

12. The computer program product of claim 9, in which the medium further comprises code:
to receiving, from the client computer, a third value represented by a bit pattern of the second computer architecture;
to transform, in the database on the host computer, the third value to a fourth value represented by a bit pattern of the first computer architecture; and
to store the fourth value in the database.

13. The computer program product of claim 12, in which the medium further comprises code
to form a second intermediate value by inserting one or more null bits into the third value;
to select a second plurality of bits corresponding to the first word length from the second intermediate value; and
to insert the second plurality of bits as a first byte of the fourth value.

14. The computer program product of claim 9, in which the first value is a binary large object (BLOB) value from a column of the database.

15. An apparatus, comprising:
a memory; and
a processor coupled to the memory, in which the processor is configured:
to receive, from a database on a host computer, a first value represented by a bit pattern of a first computer architecture;
to transform, in the database on the host computer, the first value to a second value represented by a bit pattern of a second computer architecture; and
to transfer the second value to a client computer of the second computer architecture.

16. The apparatus of claim 15, in which the first computer architecture comprises a first word length larger than a second word length of the second computer architecture, and in which the processor is further configured:
to select a first plurality of bits corresponding to the second word length from the first value; and
to insert the first plurality of bits as a first byte of the second value.

17. The apparatus of claim 16, in which the processor is further configured to form an intermediate value by inserting the first plurality of bits and one or more null bits as a first intermediate byte before inserting the first plurality of bits as the first byte of the second value.

18. The apparatus of claim 16, in which the processor is further configured to insert one or more null bits in the first value such that a length of the first value is an integer multiple of the second word length.

19. The apparatus of claim 16, in which the processor is further configured:
to receiving, from the client computer, a third value represented by a bit pattern of the second computer architecture;
to transform, in the database on the host computer, the third value to a fourth value represented by a bit pattern of the first computer architecture; and
to store the fourth value in the database.

20. The apparatus of claim 19, in which the processor is further configured:
to form a second intermediate value by inserting one or more null bits into the third value;
to select a second plurality of bits corresponding to the first word length from the second intermediate value; and
to insert the second plurality of bits as a first byte of the fourth value.
